(19) United States
(12) Patent Application Publication
(10) Pub. No.: US 2007/0299376 A1
(43) Pub. Date: Dec. 27, 2007

(54) Massage Arm

(75) Inventor: Uwe Schefthaler, Taufkirchen/Vils (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: OKIN GESELLSCHAFT FUR ANTRIEBSTECHNIK MBH, Gummersbach (DE)

(21) Appl. No.: 10/598,241

(22) PCT Filed: Feb. 24, 2005
(86) PCT No.: PCT/DE05/00319

§ 371 Date: Jun. 15, 2007

(30) Foreign Application Priority Data
Feb. 25, 2004 (DE) 20 2004 003 068.3

(51) Int. Cl. A61H 7/00; A61H 1/00

(52) U.S. Cl. 601/89; 601/134

(57) ABSTRACT

A massage arm (1), comprising a massage element (2) for a massage unit that can be incorporated into a massage chair or similar, is hinged on at least one shaft that can be moved by a drive in the massage unit, and has an articulated connection to the massage element (2). To achieve an improved massaging action with the massage arm and the attached massage elements, it is proposed that the articulated connection comprise a ball-and-socket joint (3).

The invention relates to a massage arm, comprising a massage element, for a massage unit that can be incorporated into a massage chair or similar, where said massage arm is hinged on at least one shaft that can be moved by a drive in the massage unit and is connected to the massage element by a ball-and-socket joint, where the ball-and-socket joint displays a ball head, located on the end opposite the articulated connection to the shaft, which is mounted in a ball socket located on the massage element, and the ball head displays an extension projecting beyond the ball socket for connection to the massage arm, and the massage element displays a supporting part with massage bodies for acting on the human body located on one side of the supporting part.

A massage arm of this kind with a massage element is known from U.S. Pat. No. 1,709,170. As a result of the ball head mounted in a ball socket, with an extension projecting beyond the ball socket for connection to the massage arm, the oscillation of the massage arm, generated via the shaft, can be transmitted largely without loss of power to the massage element in contact with the part of the body to be massaged. In this context, the massage element can be angled in any direction relative to the massage arm, in order to adapt to the position of the part of the body to be massaged. A restriction of angling in certain directions exists only as a result of the structural dimensions of the massage element, the ball socket located on it, the massage arm, and the extension of the ball head projecting beyond the ball socket. Beyond this, the massage element can be angled arbitrarily relative to the massage arm.

However, such largely arbitrary angling has proven to be disadvantageous, particularly when using the massage arm with the massage element in a massage chair or a back section of a recliner or a bed, where the massage element usually displays specifically oriented massage bodies for acting on the back of a sitting or lying person. After all, the massage element can rotate under certain circumstances, and then has to be moved back into its correct position when used on the next occasion, this possibly proving difficult for the user.

On the other hand, the ball socket largely surrounding the ball head can disadvantageously restrict angling of the massage elements in certain directions in a massage chair or a recliner or a bed.

The object of the invention is to further develop the articulated connection between a massage arm and a massage element of the kind described in the opening paragraph in such a way that undesired pivoting movements of the massage element relative to the massage arm are prevented, and restrictions of angling in certain directions are eliminated.

On a massage arm with massage element of the kind described in the opening paragraph, the object is solved in that the ball head displays two opposite pins, which engage opposite openings in the ball socket, the openings are of elongated design towards the edge of the ball socket and closed at the edge, such that the pivoting angle of the ball-and-socket joint in the plane formed by the two longitudinal axes of the openings is restricted to a predetermined range, the ball socket is provided with a U-shaped groove that is open towards the edge of the ball socket and into which the extension can be pivoted, and the supporting part consists of two halves, in the parting line area of each of which one half of the ball socket is integrally molded on the supporting part in one piece on the side of the supporting part opposite the massage bodies.

Owing to the pins of the ball head engaging the opposite, elongated openings in the ball socket, the pivoting angle of the massage element in the plane of the two longitudinal axes of the openings is restricted to a predetermined range.

If the massage element is only to pivot within limits in the plane containing the longitudinal directions of the two openings, the width of the openings perpendicular to their longitudinal axes is designed such that it essentially corresponds to the diameter of the pins.

The two longitudinal axes of the openings preferably extend essentially in the longitudinal direction of the massage arm, and particularly of the holding arm if the massage arm consists of a holding arm connected to a first driven shaft and a projecting arm acting on said holding arm and connected to a second driven shaft. The openings are then located parallel to the plane formed by the holding arm and the projecting arm, such that the massage element can only rotate perpendicular to this plane within limits.

Particularly if the massage arms are located in the backrest of a massage chair, they extend, when the backrest is upright, in a direction that is essentially horizontal to the back of the person sitting in the massage chair. The elongated openings in the ball socket then restrict pivoting of the massage elements about their vertical axis, thus preventing rotation about this axis.

Owing to the U-shaped groove that is open towards the edge of the ball socket and into which the extension of the ball head can be pivoted, the massage arm can be folded in relative to the massage element in the plane of symmetry passing through the U-shaped groove, e.g. in order to be able to insert or remove the massage unit into or from the backrest of a massage chair or a recliner or a bed as a compact part. The back section can be of relatively flat design as a result.

Finally, the special design of the supporting part in two halves, in the parting line area of each of which one half of the ball socket is integrally molded on the supporting part in one piece on the side of the supporting part opposite the massage bodies, achieves optimally expedient production of the massage element according to the invention.

A ball-and-socket joint connection between a massage element and a massage arm with a ball head is known from WO 01/74289 A, where the ball head is penetrated by a transverse pin, which is guided at both face ends in guide grooves of the supporting part of the massage element. This permits reciprocating motion of the massage element relative to the massage arm in the plane lying perpendicular to the transverse pin, but rotation of the massage element about the longitudinal axis of the massage arm is prevented. Since the face ends of the transverse pin lie against the side walls of the guide grooves, pivoting movement of the massage arm in the plane defined by the longitudinal axis of the massage arm and the axis of the transverse pin is not possible. Nor would a pivoting movement of this kind be restricted, since the guide grooves are open towards the edge of the square recess in which the ball head of the massage arm is mounted. Furthermore, a U-shaped groove open towards the edge of the ball head receptacle, and an extension integrally molded on the ball head for engaging this groove, are also not provided.

U.S. Pat. No. 1,799,807 discloses an articulated connection between a massage arm and a massage element that consists of two swiveling shafts arranged crosswise. The one shaft, whose ends are connected to fork-like limbs on the massage element, acts through one opening in each of the limbs, but said opening is not of elongated design and thus does not permit pivoting over a predetermined range. The position of the other shaft is also fixed on a sleeve of the massage arm.

In the present invention, the ball head can alternatively be connected not to the massage arm, but to the massage element, and mounted in a ball socket located on the massage arm.

The massage arm can be designed in various known embodiments. The massage unit customarily consists of a massage carriage, which can be incorporated into the backrest of a massage chair, or into another item of furniture to be equipped with a massage unit, and can be moved back and forth along a frame by means of a drive. As a rule, the massage carriage displays two motor-driven shafts, via which oscillation of two massage arms, each provided with a massage element, is generated. To this end, each massage arm expediently consists of a holding arm, connected in articulated fashion to the one shaft, on the free end of which the massage element is located, and a projecting arm, connected in articulated fashion to the second shaft, one end of which acts on the holding arm. To generate the oscillation, the ends of both shafts can display eccentric areas, on which the holding arm and the projecting arm are mounted. In this context, the eccentric areas at the ends of the shaft connected to the holding arm can be angled relative to this shaft, such that, when this shaft rotates, the holding arms bearing the massage elements perform a pivoting movement about an essentially horizontal axis extending through the intersection of the shaft in question and the angled axis of the eccentric areas. The massaging action generated by this movement of the massage elements is referred to as “kneading”.

The movement of the shaft connected to the projecting arm is such that, when superimposed on the eccentric oscillation of the shaft connected to the holding arms, essentially vertical movement of the massage elements is generated via the projecting arms, possibly with a component oriented perpendicular to the frame. The massaging action exerted by this movement is also referred to as “tapping”.

Massage arms of this kind are known from WO 97/37627 A, for example. The roller-shaped massage elements located on the holding arms can be rotated about an essentially horizontally oriented axis.

On other known massage arms, the massage elements are of flat or hand-shaped design, and act on the back of the person sitting in the massage chair or similar through several attached massage bodies.

The supporting part halves and the ball socket halves are expediently each designed as plastic parts, injection-molded in one piece.

A practical example of the invention is explained in more detail below on the basis of the drawing. The Figures show the following:

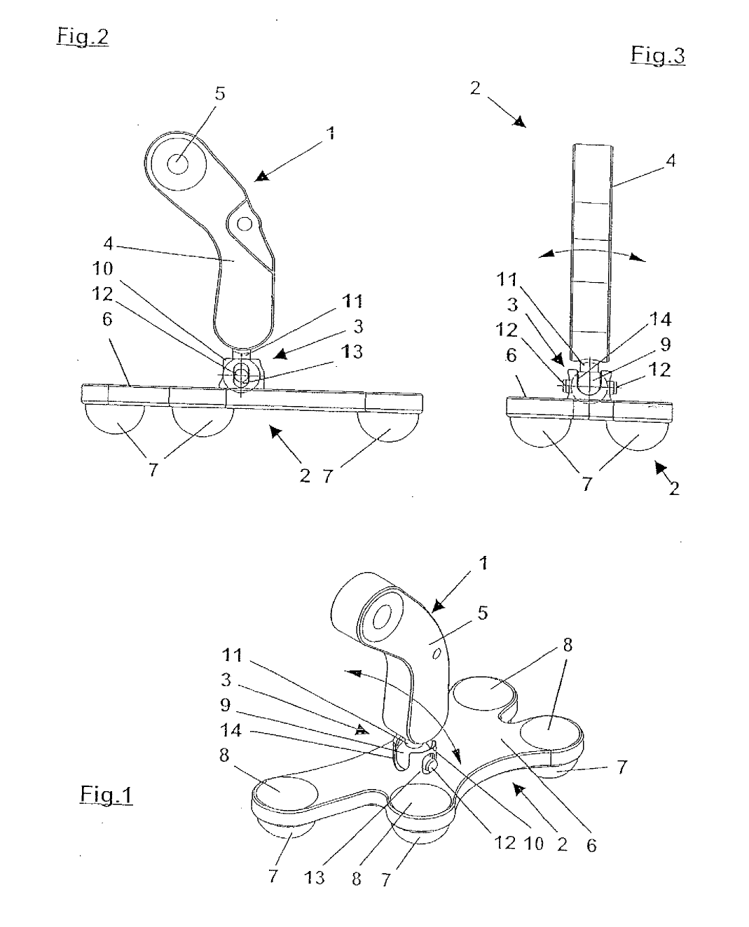

FIG. 1 A perspective representation of a massage arm, with an attached massage element,

FIG. 2 A side view of the massage arm with massage element illustrated in FIG. 1, and

FIG. 3 A front view of the massage arm with massage element illustrated in FIG. 1.

In the practical example of a massage arm 1 with a massage element 2 illustrated in the drawing, massage arm 1 is connected to massage element 2 by a kind of spherical cardan joint 3.

The drawing shows only holding arm 4 of massage arm 1, said holding arm 4 being freely mounted in a bearing arrangement 5 on a motor-driven shaft not shown in the drawing. Mounting is performed on an eccentric end of the shaft that is arranged at an angle relative to the shaft in a direction such that both eccentric oscillation of holding arm 4 parallel to the drawing plane of FIG. 2 is generated, and also pivoting of holding arm 4 perpendicular to the drawing plane of FIG. 2.

Hinged on the middle section of holding arm 4 is a projecting arm, not shown in the drawing, which has an articulated connection to a second shaft, likewise not shown in the drawing. Via the motor-driven movement of the second shaft, an oscillating movement is likewise generated in the projecting arm and, via it, in holding arm 4, said oscillating movement running essentially parallel to massage element 2, possibly with a component perpendicular to massage element 2. When superimposed on the eccentric movement of holding arm 4, this oscillating movement leads to so-called “tapping” motion, whereas pivoting of holding arm 4 essentially in the vertical plane perpendicular to the drawing plane of FIG. 2 causes so-called “kneading” motion.

As can likewise be seen from the drawing, massage element 2 consists of a flat, hand-shaped supporting part 6, with massage bodies for acting on the human body located on the side opposite holding arm 4. Corresponding openings 8 are provided in supporting part 6 to accommodate the roughly hemispherical massage bodies 7. Four massage bodies 7 are provided in the practical example illustrated in the drawing. Their shape and number can, of course, be selected in accordance with the respective requirements.

As can be seen from the drawing, spherical cardan joint 3 connecting massage arm 1 to massage element 2 consists of a ball head 9, located on the end of holding arm 4 opposite articulated connection 5, and a ball socket 10, integrally molded on the side of supporting part 6 opposite massage bodies 7. Ball head 9 is connected to holding arm 4 via a cylindrical extension 11.

Ball head 9 displays two opposite pins 12, which extend perpendicular to the massage arm and engage opposite openings 13 in ball socket 10. Pins 12 and openings 13 prevent rotation of massage element 2 about the axis of cylindrical extension 11 of ball head 9.

Openings 13 are of elongated design in the axial direction of cylindrical extension 11 of ball head 9, such that the pivoting angle of the articulated connection between massage arm 1 and massage element 2 in the vertical plane perpendicular to the drawing plane of FIG. 2 is restricted to a predetermined range. This prevents rotation of massage element 2 in this plane.

As can be seen particularly from FIGS. 1 and 3, ball socket 10 is provided with a U-shaped groove 14 that is open towards the edge of ball socket 10 and into which cylindrical extension 11 of ball head 9 can be pivoted. Groove 14 is located in the plane of massage arm 1 parallel to the drawing plane of FIG. 2 and perpendicular to the drawing plane of FIG. 3, such that massage arm 1 can be folded in relative to massage element 2 in this plane.

Supporting part 6 of massage element 2 is (not shown in the drawing) made up of two halves, on the parting line of each of which one half of ball socket 10 is integrally molded in one piece, such that ball head 9 of massage arm 3 can be accommodated between the ball socket halves. The supporting part halves with the integrally molded ball socket halves are connected to each other by suitable fastening means.

The supporting part halves and the ball socket halves integrally molded thereon are in each case designed as plastic parts, injection-molded in one piece.
1 Massage arm
2 Massage element
3 Spherical cardan joint
4 Holding arm
5 Bearing arrangement
6 Supporting part
7 Massage body
8 Opening
9 Ball head
10 Ball socket
11 Extension
12 Pin
13 Opening
14 U-shaped groove

1. Massage arm (1), comprising a massage element (2), for a massage unit that can be incorporated into a massage chair or similar, where said massage arm (1) is hinged on at least one shaft that can be moved by a drive in the massage unit and is connected to the massage element (2) by a ball-and-socket joint (3), where the ball-and-socket joint (3) displays a ball head (9), located on the end opposite the articulated connection (5) to the shaft, which is mounted in a ball socket (10) located on the massage element (2), and the ball head (9) displays an extension (11) projecting beyond the ball socket (10) for connection to the massage arm (1), and the massage element (2) displays a supporting part (6) with massage bodies (7) for acting on the human body located on one side of the supporting part (6), characterized in that the ball head (9) displays two opposite pins (12), which engage opposite openings (13) in the ball socket (9), the openings (13) are of elongated design towards the edge of the ball socket (10) and closed at the edge, such that the pivoting angle of the ball-and-socket joint (3) in the plane formed by the two longitudinal axes of the openings (13) is restricted to a predetermined range, the ball socket (10) is provided with a U-shaped groove (14) that is open towards the edge of the ball socket (10) and into which the extension (11) can be pivoted, and the supporting part (6) consists of two halves, in the parting line area of each of which one half of the ball socket (10) is integrally molded on the supporting part (6) in one piece on the side of the supporting part (6) opposite the massage bodies (7).

2-6. (canceled)

7. Massage arm according to claim 1, characterized in that the supporting part halves and the ball socket halves are in each case designed as plastic parts, injection-molded in one piece.
